(19) United States
(12) Patent Application Publication
(10) Pub. No.: US 2014/0052489 A1
(43) Pub. Date: Feb. 20, 2014

(54) TIME DERIVATIVE-BASED PROGRAM MANAGEMENT SYSTEMS AND METHODS

(71) Applicant: FLUOR TECHNOLOGIES CORPORATION, Aliso Viejo, CA (US)

(72) Inventor: Robert Prieto, Princeton Junction, NJ (US)

(73) Assignee: FLUOR TECHNOLOGIES CORPORATION, Aliso Viejo, CA (US)

(21) Appl. No.: 13/633,676

(22) Filed: Oct. 2, 2012

Related U.S. Application Data
(60) Provisional application No. 61/683,633, filed on Aug. 15, 2012.

(51) Int. Cl. G06Q 10/06

(52) U.S. Cl. 705/7.23

(57) ABSTRACT

Systems and methods for program management are presented. A user can perform analysis and evaluate levels of potential disruption or efficiency that exist in a program or a project thereof through one or more project metrics of a program. Understanding disruption and efficiency indices in a program can help evaluate the duration, location, reason, or severity of the disruption, and assist the program team to take appropriate measures to rectify or prevent the disruption. Disruption metrics in a program can be assessed based on computation of higher order time derivatives of one or more project metrics, such computation of at least a third order time derivative to reveal pattern or other characteristics of the disruption or efficiency or inefficiency in the program.

This application claims the benefit of priority to U.S. provisional application having Ser. No. 61/683,633 filed Aug. 15, 2012. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is program management technologies.

### BACKGROUND

A project is a set of tasks performed to achieve a pre-defined objective. Projects are carried out keeping specific measurable metrics under consideration such as duration, resources to be used, schedule, cost incurred, risk involved, or man power investments, which are interchangeably referred to as project metrics hereinafter. Organizations typically perform substantive research work before initiating a new project so that the project can be completed successfully. Sometimes, such organizations initiate programs, each of which can comprise of multiple projects running simultaneously possibly spanning decades or even over 100 years, wherein the programs not only need better research work before start up, but also need constant observation and management during execution, which is commonly referred to as program management. In view that programs can cover large expanses of time small, apparently inconsequential issues that would ordinarily not affect a single short term project could cause ripples through time or through projects in the program, and balloon into program threatening events.

A number of analysis frameworks are used in programs to analyze and measure progress of the program as a whole or of each project within such program, with respect to time. Such frameworks can help in analyzing the projects through one or a combination of project metrics, comparing progress of the projects with respect to other projects in a program, and in understanding how the project metrics related to a particular project are progressing. Different management strategies have implemented different algorithms and analysis tools for better operation of the projects. These algorithms and analysis tools typically read the data stored in a database of a project and calculate project metrics using algorithms to come out with a result, which is analyzed to identify the progress of the project. However, as projects have grown more complex, project performance analysis framework tools have remained unchanged. Although, the present analysis framework tools are powerful enough to manage a large volume of data, these tools merely generate statistical data about the project metrics and do not provide exact information about the reason behind a disruption or an efficiency shown by one or a combination of project metrics during a particular duration of time of the project, especially across expansive programs.

Typically, the progress or achievement of a project is measured at defined intervals with respect to metrics such as cost, schedule, percentage of work completed, risk, or man-hours, wherein these metrics include an absolute value or datum, which is a value recorded at a predetermined time period. Generally, progress or achievement of a project is calculated and analyzed by drawing an achievement curve with respect to relatively common set of project metrics, wherein the achievement curve helps compare the projects metrics with respect to planned thresholds. These tools use project metrics to calculate the progress of the project by computing the rate of change of a project metric with respect to time, which is the first order time derivative of the project metric. The tools, in limited instances, are also used to calculate the rate of change of progress, which is interchangeably referred to as ramp rate of the project. The ramp rate, as a result, becomes the second order time derivative of the concerned project metric. The first order time derivative and the second order time derivative of a project metric merely provides information about the quantity of project metric invested or used during a defined period of time and indicate whether the project is on track but does not provide any information about disruption or efficiency shown by the project metric during the period. The Applicant has appreciated that to identify such disruption or efficiency that occurs at a certain time period and analyze reason for the event, a third order or higher order time derivative can be calculated with respect to one or more a combination of project metrics. Through the Applicant's disclosed techniques, disruptions or efficiency, with respect to projects or programs, can be determined, possibly as a leading indicator of future issues.

U.S. patent application 2012/0054764 to Bagheri et al. titled “Automated Allocation of Resources to Functional Areas of an Enterprise Activity Environment”, filed Aug. 25, 2010, discusses measurement of disruption as a cohesive index with respect to changes in personnel, but does not provide for a higher order time derivative of a project metric.

Another, more generic example includes U.S. patent application 2010/0010856 to Chua et al. titled “Method and System for Constraint-Based Project Scheduling”, filed internationally on Feb. 8, 2007, which merely suggests buffer management in an attempt to reduce disruption to a project. Although Chua discusses constraint based project scheduling using buffers or inventories to reduce disruptions in construction process by proactively tracking constraint status and deploying preemptive measures for the current period and next period, the scheduling method comprises of two databases, wherein one database stores project scheduling data and the second database stores data associated with look ahead plan for the next period. Chua does not provide for calculation, identification, or analysis of disruption or efficiency of project metrics of a project.

U.S. patent applications 2011/0078301 to Dehaan titled “Systems and Methods for Detecting Network Conditions Based on Correlation Between Trend Lines”, and 2011/0078302 also to Dehaan titled “Systems and Methods for Detecting Network Conditions Based on Derivates of Event Trending”, both filed on Sep. 30, 2009, discuss using higher order time derivates to detect network events. Useful for network event detection where traffic can be highly unpredictable, the disclosure of Dehaan fails to provide that the higher order derivates can be used to smooth or guide traffic flow, let alone project or program management.

The above discussed materials merely disclose identification of disruption in completely different subject matters and also fail to provide project or program management as the field of application. These materials also fail to provide for computation of higher order time derivates to identify and analyse portions of disruption or efficiency in project metrics. Furthermore, the known first and second order time derivatives of project metrics merely provide for faults or errors that have occurred in a project but do not cater to identification of more meaningful information such as the reason, pattern, trend for such fault and error, which are desirable for efficient program management.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for a program management system and method that can identify, analyze, compare, and evaluate potential disruption or efficiency in one or more project metrics of a project of a program by utilizing higher order time derivatives, specifically, third order time derivative and fourth order time derivative of one or more project metrics.

### SUMMARY OF THE INVENTION

The inventive subject matter provides systems and methods for project management in which one can perform analysis on one or more project metrics and evaluate the level of potential disruptions or efficiencies that exists in a program and understand the duration, reason, or severity of the disruption or efficiency, which helps in understanding how various disruptions combine together to affect overall efficiency of the project. One aspect of the inventive subject matter includes assessment of disruption in a program based on higher order time derivative of one or more project metrics, as higher order time derivatives such as third order derivatives and above, reveal patterns or events of one or a combination of project metrics, which lower order time derivative fail to identify.

The inventive subject matter is considered to include a project management system comprising a project database and a project analysis engine operatively coupled with the project database. The project database can be configured to store project metrics with respect to time, wherein the project metrics are associated with a program, or projects related to a program, and can include cost incurred, resources utilized, schedule, completion percentage, personnel usage, man-hour usage, or such parameters that define or characterize attributes of the program. The project analysis engine can be configured to access the project database to select at least one of the project metrics of the project and calculate a disruption metric as a function of at least a third order time derivative of the project metric. The disruption metric can include a disruption index, which is defined to be derived specifically from the third order time derivative of the project metric and which represents jerk or disruption changes in the project metric in the project. A project achievement curve (e.g., planned loading curve, estimated progress curve, etc.), can be obtained based on the project metric and can be displayed on an output device with respect to the disruption metric to portray the duration, timestamp, location, severity of disruption or jerk, or other disruptive aspect of the program. Further, the distribution metric can include an efficiency index, which is defined to be derived specifically from the fourth order time derivative of the program metric and represents a snap or jounce associated with changes in the project metric.

The disruption metrics (e.g., disruptions index, efficiency index, or other higher order effects) can indicate detailed as well as overall disruption that occur in a project plan in a spatial context by presenting jerks or snaps that happen over a defined period of time. In an aspect of the inventive subject matter, project analysis engine calculates a higher order time derivative of one or more project metrics to identify pattern, correlations, reason, timestamp, or event of disruption that occurs in the project metrics, which are not indicated or identified by the rate of change of absolute values of the project metric (first order time derivative or progress rate) and changes in rate of progress (second order time derivative or ramp rate). Thus, calculating and analyzing disruption in one or more project metrics of a project through third and higher order time derivatives can help in identifying occurrence of the disruption during a defined duration of time and assist the program team to take necessary measures to mitigate or remove the risks. In an aspect of the inventive subject matter, disruption indicated by one or more project metrics of a project can be compared with disruption indicated by project metrics of other projects and to help understand the performance of each project with respect to one another.

Another aspect of the inventive subject matter is considered to include a method of project management to identify disruption or efficiency in one or a combination of project metrics of a project. The method can include storing one or more project metrics associated with a project in a project database with respect to time. The method can further include deriving a disruption metric as a function of at least a third order time derivative of one or more project metrics of the project. The method can further include obtaining a project achievement curve based on the one or more project metrics. Another step of the method can include displaying the disruption metric with respect to the project achievement curve to identify disruption or jerk occurring in the project through the one or more project metrics over a period of time.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic of a program management system comprising a database and a project analysis engine coupled via a network.

FIG. 2A is a schematic of a graphical representation of an analytical comparison between projected and actual project metrics.

FIG. 2B is a schematic of a graphical representation showing jerks and snaps through third order and fourth order time derivatives of the project metrics.

FIG. 3A is a schematic of a graphic representation showing an S-curve of program progress.

FIG. 3B is a schematic of a graphic representation showing jerk in the program.

FIG. 3C is a schematic of a graphic representation showing snap in the program.

FIG. 4 is an example method of program management.

### DETAILED DESCRIPTION

It should be noted that while the following description is drawn to time derivative-based program management systems and methods, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed system. In especially preferred embodiments, the various servers, systems, databases, or interfaces exchange data using standardized protocols or algorithms, possibly based on HTTP, HTTPS, AES, public-private key exchanges, web service APIs, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including generating signals representative of program disruption and configuring output devices to present the disruption. The signals can include one or more packets of program disruption data conveyed over a network (e.g., the Internet, cell phone network, etc.) and received by an electronic device operating as the output device. In response, the electronic device configures itself according to the signal to present disruption information.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The following discussion describes the inventive subject matter with respect to various numbers of records relating to metrics of a program in databases. One skilled in the art will recognize that the inventive subject matter can scale as necessary to any number of items without departing from the inventive subject matter.

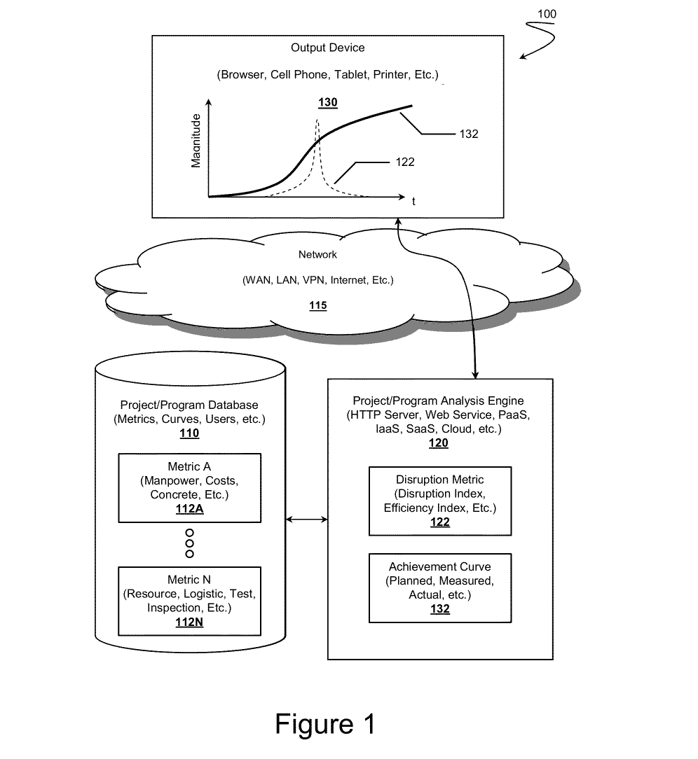

In FIG. 1, program management system 100 comprises of a project database 110, a project analysis engine 120 operatively coupled to the project database 110, and an output device 130. The project database 110, the project analysis engine 120, and the output device 130 can be operatively connected to each other by a network 115. Network 115 can either be a wired or a wireless network and can comprise a WAN, LAN, VPN, the Internet, cellular telephone network, or other types of network. The project database 110, alternatively also referred to as program database 110 hereinafter, can be configured to store one or more project or program metrics 112A, 112B . . . 112N, which define, present, or objectify the progress or characteristics of a project or program. The project metrics 112A . . . 112N, collectively referred to as project metrics 112 hereinafter, can be associated with a program, or one or more projects related to a program, and can include manpower utilized, cost incurred, resources used, logistics, schedule, test, inspection, completion percentage, personnel usage, man-hour usage, among other such program related metrics.

During execution or implementation of a program, particularly programs having one or more projects spanning extensive periods of time, each of which has a complex and sizeable scope and structure, control of the program must be based on information obtained directly or indirectly from observing or measuring program parameters that are capable of characterizing the program and providing useful information based on which a sound control strategy can be based. Such program parameters, also referred to as project metrics 112, can be measured continuously or substantially instantaneously over the period of the program. Among the variety of project metrics 112 available, as would also be highlighted below, which can be used to characterize any particular program, use of appropriate metrics and assessment of their accurate meaning are key to efficient control of the program and early or sensitive detection of a potential problem. Certain project metrics can also be predictive of future progress of the program, but even for them, the key to controlled and accurate analysis of the program lies in planned layout and detailed computation of such metrics such that, apart from the overview information given by such metrics, the focus lies on the inherent behavior of the change portrayed by the metrics and events responsible for such change.

The applicant has appreciated that higher order derivatives of project metrics 112 with respect to time can represent significant indicators of project or program performance, where, lower order time derivatives such as first or second order time derivatives merely highlight the rate or progress of a program but do not help understand the reasons and rational behind such a rate and therefore do not give an insight about the manner in which the project is being planned, scheduled, or executed. A higher order time derivative, such as a third order time derivative of one or more project metrics 112, on the other hand, can indicate disruption in a program i.e. the third order time derivative can indicate when a sudden disruptive event took place, duration for which the event persisted, or the activities being undertaken in the program during the occurrence of the disruptive event. Such disruptive events can be depicted through third order time derivative of one of the project metrics or can be depicted consistently across third order derivatives for all selected project metrics. Therefore, a program that might appear to be running normal or on-time in context of a particular project metric, can actually have a disruption when another project metric or a group of project metrics are considered, and therefore third order time derivatives can give a holistic as well as in-depth representation of the disruption.

Further, a higher order time derivative such as a fourth order time derivative of a project metric can indicate the level of efficiency or inefficiency in a program, i.e. the fourth order time derivative can indicate when a program shows sudden or consistent improvement or inefficiency over a period of time. A fourth order time derivative represents the change in third order time derivative and therefore is configured to represent the noise or disruptions caused or detected in the third order time derivative. Thus, the fourth order time derivative can be considered representative of a level of efficiency or inefficiency in the program. The fourth order time derivative can also be used to detect efficiencies in behavior of project metrics over a period of time that are not detected as disruptions by the third order derivative calculations, thereby increasing the sensitivity to change in project metrics over a given time instant. Furthermore, as each project metric represents a different view of the program progress, one metric might not necessarily reflect efficient application of a resource in a project with respect to a particular point of view, whereas other metrics might appear to represent efficient application of different resources. For example, consider cost and man-hours as two project metrics in a project over a small period of time, T. The project could be executed such that, when looked from the perspective of cost as the project metric through analysis of the third order time derivative of cost, it appears to be running smoothly or as planned without any disruptions. Furthermore, it can also be possible that the fourth order time derivative of the cost project metric shows that the metric lacks efficiency and has multiple small duration negative changes in disruptions. In such a case, it can also be possible that when a fourth order time derivative of man-hours is computed for the same time period, the time derivative depicts a strong efficiency with respect to man-hours spent during a portion of time period T with some number of man-hours saved during the portion. Therefore, multiple project metrics or even higher order derivatives of a single metric can yield different views of behavior or impact of the project metric 112 on the program, and as a result, metrics 112 can be treated individually or in combination.

With programs, and projects therein, becoming large and diverse in scope and size, the time horizon for project metrics 112 too must be expanded. For example, disruptions indicated by analysis of program metrics can have an impact, possibly indirectly, long after the occurrence of the initial disruption. In addition to some exemplary project metrics 112 mentioned above, a number of additional project metrics 112 can be extracted, retrieved or derived from multiple parts of the program or its projects, wherein these project metrics 112 describe attributes of or information related to the program. It should be appreciated that certain exemplary project metrics can be common across most programs and can include indicators of development effort, development time-scale, earned value vs. actual cost, program risk, technology risk, or organization impact. Certain other metrics can, on the other hand, be specific to industry based programs. For example, a software development project can include metrics relating to features in the product, size of the application, computer time, lines of code, number of scope change requests, number of scope change approvals, among others. Development effort can typically be measured based on people effort, capital equipment investment, or organization on-costs such as accommodation, consumables, etc, which can all be considered as separate project metrics.

Further, apart from conventional project metrics, a number of new or customized project metrics can be defined where analysis of one or a combination such introduced project metrics can throw deeper insights into the execution, planning, or implementation of a program. Certain exemplary project metrics can include email communications of program or project teams, text messages, employee retention, recruitment pattern, inputs from multiple project management tools, quality reviews and number of defects, extent of rework, stakeholder involvement, impact on management, change in scope, cost-performance indicator, schedule performance index (SPI), sensor outputs, response times, an index indicating comparison between planned value (PV), actual cost (AC) and Earned Value (EV), or other such measures that are directly or indirectly indicative of the above.

Project metrics 112 can be stored in such a manner that the data relating to these metrics 112 can easily be categorized and retrieved to analyze the project with respect to their progress, resource utilization, among other attributes. For example, a project metric 112 can represent the “percentage of work completed in the project”. Although this and other forthcoming embodiments of the present disclosure are explained with respect of this project metric, it would be well appreciated that project metrics can include any parameter that can define or be associated with a project or program. Various other project metrics 112 can, individually or in combination with other, be analyzed to derive their respective third order and fourth order time derivatives to identify disruptions or efficiencies in the project. It has been appreciated by the applicant that a project metric 112 can be presented in a time-series model to explain the change in values of project metric 112 over a defined period of time. Before the project analysis engine 120 processes the project metric 112, the time-series fitted model can also be refined to determine if the model is stationery or presents some seasonality or periodicity in behavior.

In an embodiment, project analysis engine 120, alternatively also referred to as program analysis engine 120 hereinafter, can be implemented in a server such as a HTTP server or as a web service, PaaS, Iaas, SaaS, cloud or the like. Analysis engine 120 can be configured to access project database 110 to select at least one project metric 112 of a project and calculate a disruption metric 122 as a function of at least a third order time derivative of the project metric. Third order time derivative of a project metric 112, as described above, can be computed by calculating the change in ramp rate or acceleration (second order time derivative) of the concerned project metric 112 with respect to time. Ramp rate represents the change in rate of change of a particular project metric with respect to time. For example, in case the project metric 112 represents % of work completed, change in percentage of work with respect to time, say from 5% to 9% in 5 days (4% per 5 days) and 9% to 11% in the next 5 days (2% per 5 days) represent velocities of the project metric 112 calculated at five day intervals. A ramp rate of change of the project metric 112, on the other hand, represents the acceleration, i.e. the acceleration represents rate of change the velocities (−2% per 5 days) with respect to work completion in 5 days, wherein such acceleration can be computed on a daily basis or according to other desired time interval. Third order time derivative, on the other hand, further evaluates the change in project metric over a period of time and focuses on instantaneous changes in acceleration, which is also commonly referred to as “jerk” in physics. Therefore, increases in acceleration of project metric 112 result in positive values of the third the third order time derivative of project metric 112. Such deviations of actual project metrics from planned values can lead to higher jerks or disruptions, which can be monitored, identified, or evaluated by the third order time derivatives.

Disruption metric 122 is consider a function of at least a third order time derivative where the metric 122 can represent change in rates of change of the project metric 112 with respect to time and hence can help determine the extent, severity, location, or time duration of the change, which can help assess the progress of the program or evaluate its overall impact or performance. The disruption metric 122 can therefore be a measure of a possible destructive effect of a particular jerk or disruption that is represented by the third order time derivative of a project metric 112 at a given time. The disruption metric 122 of the present disclosure can either be a single value representative of the disruption at a given time or can be a combination of multiple values including third order time derivative values or higher order time derivative values of a project metric. Further, disruption metric 122 can either be independent of or separate for each project metric 112 or can combine representation of third order derivatives for a plurality of project metrics 112. Thus, disruption metric 122 can include additional partial derivatives with respect to other factors or metrics 112 in addition to time.

The disruption metric 122 can include a disruption index, which can be derived from the third order time derivative of the project metric, and can represent the magnitude or severity of jerk or disruption that occurs in the project in view of the project metric. Disruption metric 122 can include one or more disruption indices, wherein each disruption index is derived from one or more project metrics. Multiple disruption indices representing higher order time derivatives of multiple project metrics can be grouped, associated, averaged, or correlated for a particular time window, for better assessment and evaluation of the disruption caused. The time window can either be user defined or configurable, or can be set automatically by the program analysis engine 120. Disruption indices can also be compared with defined thresholds, which may or may not be project metric specific, to help understand the extent to disruption. Although the disruption index is derived from a project metric and represents the magnitude of disruption, a deeper analysis of the disruption index can result in understanding when the disruption or sudden jerk took place, the duration for which the disruption existed, among other desirable attributes of the detected disruption. The disruption indices can be considered a function of the third order derivatives. Therefore, a single disruption metric 122 can give rise to one or more disruption indices depending on the desired analysis or analytical value.

It should be appreciated that a disruption might not always relate to lower or inefficient execution of an activity and can also be a result of a natural or unexpected problems. For example, during the connection of two legs (north leg and south leg) of a building with each other at the top, sunlight hitting the south leg can make the metals to expand, which can prevent the legs to be aligned with respect to each other. Such a disruption is not due to inefficient execution but still makes an impact on the project and therefore, in such a case, the severity or magnitude of disruption can be indicated by the disruption index of the disruption metric 122.

As has been described above, project metrics 112 can also include multiple user defined metrics, third order time derivatives of which can be used to flag abrupt or disruptive events. For example, change in rate of exchange of emails between two parties involved in a particular project can be an indicator of a disruption in the project, specifically in the activity defined in the subject line of the emails. Disruption index can therefore be derived based on the third order time derivative of email project metric and an appropriate action can be taken. Furthermore, it should be appreciated that a disruption can also exist or take place in case there is no jerk in a particular project metric over a defined period of time. For example, in case an activity was planned to be initiated on 15'th July, which was expected to raise the cost of the project by USD 500,000, the lack of change in the rate of change of the cost project metric till 18'th July could mean a disruption in the project and a possible suggestion of non-initiation of the activity. In this example, the farther the date of non-change in cost project metric is from 15'th July, the higher can be the value of the disruption index. In other words, a delay in a start date can be an indictor of future disruptions.

It should be appreciated that multiple other mechanisms can be incorporated for computing third or higher order time derivatives of the project metrics. In one such way, a project metric 112 can first be retrieved from the database 110 and transformed by the program analysis engine 120 by applying a third or higher order lag factor to the metric 112 to produce a lagged project metric and then generating a signal which is the time derivative of the lagged project metric to output the third order time derivative. The third or higher order lag factor, in such a case, can be applied using techniques such as Laplace transform.

An achievement curve 132 can be obtained based on one or more project metrics 112 and can represent actual or planned progress or achievement of the project or program. Disruption metric 122, which is presented through one or more disruption indices, can be displayed on an output device 130 with respect to the achievement curve 132 to portray the duration, timestamp, location, severity of disruption or jerk, or other disruptive attributes of the project. As each disruption index is derived from a third order or higher time derivative of the project metric, it represents the change in rate of change (second order time derivative) of the project metric and therefore indicates the actual reason for the disruption or jerk in a project instead of merely indicating the rate of progress of project. Understanding the actual reason behind the jerk can, as a result, help the people and activities responsible for the jerk and assist in taking necessary measures to overcome the inefficiencies. The output device 130 can be a web browser, a cell phone, a tablet, a printer, a computer device or other type of suitable device.

Achievement curve 132 can also be obtained based on planned values for project metrics 112 such as planned schedule, cost, expenditure rates, man-hours, installation rates, or earned value, before or after initiation of the project. Multiple achievement curves 132 can also be represented at the output device 130 for one or a combination of project metrics 112. In another instance, achievement curve 132 can also be modeled or simulated based on previous similar projects, projections of subject matter experts who can make objective assumptions around efficiency with which certain activities would be carried out and also efficiency with which transition between activities would take place (start:stop; ramp-up:ramp-down), or known simulation models such as Monte Carlo techniques. Therefore, achievement curve 132 could be built based on a statistical aggregation of model programs or projects from Monte Carlo simulations. Project metric data that is represented with respect to time by the achievement curve can be hereinafter referred to as baseline data.

Achievement curve 132 can be represented as a mathematical equation (e.g., a curve, a fitted curve to actual data, fitted curve simulation data, hybrid data, etc.), which aims to represent utilization of resources over the proposed time of the project. The curve 132 can also be illustrated as a combination of two or more curves that help represent side by side comparisons of actual time and expenditure components (actual project metric values) vs. proposed time and costs allocations of specific resources (planned values for the project metrics).

Presentation of disruption metric 122 with respect to the achievement curve 132 can help conclude which parameters or attributes of the program caused the disruption and notify the program team to take necessary action along with comprehensive suggestions retrieved based on the attributes of disruption. It should be noted that as the third order time derivative measures change in project metrics with respect to three degrees of time, a disruption index can be reported sooner or before an abnormal activity occurs. For example, an earlier disruption can be noticed through a man-hours project metric as well as through cost project metric. The disruption index could be determined to be above a defined threshold. In response, the program analysis engine 120 can send a message to the program team to allocate additional man-hours (resources) to a particular activity that caused the disruption to prevent further issues. The message can be sent through multiple formats such as an email, SMS, automatic voice, sensor activation, among others, wherein the message can indicate further information relating to what the additional resources are intended to do, what their respective targets would be, time when they need to be allocated, what would be the impact of such allocation of resources on other parallel activities, additional cost impact through allocation of resources, or other suggestions.

In some embodiments, disruption metric 122 can include an efficiency index, which is considered a fourth order time derivative of one or more project metrics 112 and can represent a snap or jounce associated with changes in the one or more project metrics. An efficiency index is considered representative of the efficiencies or inefficiencies in a program caused due to one or more project metrics 112 at a given time interval and is computed as the instantaneous change in jerk, or the change in disruption indices with time. Efficiency or inefficiency in a program can refine the metric change profile under consideration to assess whether the change is positive or negative, or efficient or inefficient and to further assess whether the instantaneous change in jerk fall within defined boundaries.

Consider earned value as a project metric 112 under consideration. Assuming that the daily earned value changes from 500 to 450 in a span of 5 days resulting in a rate of change (velocity) of 10 units per day. The change in rate of change (acceleration) such as from 490 on second day to 440 on third day to 450 on fifth day would depict the second order time derivative. Further, the change in second order time derivative can, through a third order time derivative, highlight the rationale behind change in acceleration on a monthly, weakly, daily, hourly, minute, or other time basis. Fourth order time derivative, on the other hand, represents the rate of change in jerk as a snap, or sometimes referred to as jounce, and whether the rate of change in jerk or disruption is within controllable limits. Therefore, even though the disruption index for “earned value” may indicate that the change from 440 on third day to 450 on fifth day causes a jerk that is above a defined threshold, the efficiency index may present the result as positive jounce if the controlled value for efficiency index is say between 450 and 550. A motion profile of a project metric under a range bounded jounce can therefore reduce overall disruptions more effectively.

An efficiency index can be used along with disruption index to assess the magnitude of disruption, the event causing it, duration of the event, or other relevant parameters using the disruption index. Analysis engine 120 can evaluate the impact of disruption(s) on the efficiency of the project metric using the efficiency index and make an informed decision of reporting suggestions to the program team for proactive risk mitigation.

Disruption metric 122 can include one or more efficiency indices, wherein each efficiency index is derived from one or more project metrics. Multiple efficiency indices, representing fourth order time derivatives of multiple project metrics, can also be grouped, associated, averaged, or correlated for a particular time window, for better assessment and evaluation of the efficiency in the project. The time window can either be user defined or configurable or can be set automatically by the program analysis engine 120. Efficiency indices can also be compared with defined thresholds, which may or may not be project metric specific, to help understand the extent to efficiency. Although the efficiency index is derived from a project metric and represents the magnitude of efficiency, a deeper analysis of the efficiency index can result in understanding the event responsible for affecting the efficiency of the project, the duration for which the event existed, among other desirable attributes of the detected event.

Efficiency indexes and disruption indexes for multiple project metrics can also be combined in a linear equation with separate or similar weights for each efficiency index and each disruption index so as to take a computationally faster decision on the suggestions to be given to the program team to handle the disruption. The weights can either be predefined based on the relative importance of each project metric under consideration or can be user configured during run-time assessment of the disruption and extent of efficiency.

In an exemplary implementation, the percentage of work completed in a project can be stored in a project database 110 as a project metric 112 and can be updated periodically with respect to time. The periodicity of updating the project database 110 can be hourly, daily, once in two days, weekly, once in two weeks, monthly, or any other time interval based on the user requirement. One should keep in mind that project metrics 112 can have temporal horizons within a program over years, decades, or even a century. Project analysis engine 120 can access the project database 110 to retrieve the percentage of work completed in the project for analysis. The percentage of work completed 112 in the project can then be analyzed by the project analysis engine 120 for computation of a third order time derivative of the metric 112. A disruption metric 122 can be created as a function of the computed third order time derivative and can be configured to store the resulting disruption index that is derived from the computed third order time derivative. As discussed above, the first order time derivative that is indicative of the progress rate, and second order time derivative that is indicative of the ramp rate of the metric 112, can also be computed alongside and stored separate from the disruption metric 122. Further, the disruption metric 122 can also be configured to calculate fourth and higher order time derivatives of one or more project metrics 112 and stored as further indices in the disruption metric 122.

Third order time derivative of a project metric 112 can be calculated by identifying change in ramp rate or change in second order time derivative i.e., by identifying changes that occur in rate of change of percentage of work completed in a project over a defined period of time. In the present example, assuming in three days the percentage of work completed increases from 3% to 6%, the rate of change in work completed is 1% per day and change in rate of change (second order time derivative) would give an indication of how fast or slow “the percentage of work completed” becomes in a day or over the period of time. The third order time derivative can therefore be computed as the rate of change of second order, which can, for much smaller time intervals, detect the change in acceleration of the percentage of work completed and yield areas where the change represents an instantaneous disruption or jerk. Similarly, fourth order time derivative (efficiency index) of a project metric 112 can be calculated by identifying changes that occur in the third order time derivative of one or more project metrics. Third order time derivative of the project metric 112 gives a disruption index of the project metric 112, which, when measured alongside time, can indicate event responsible, location, duration, timestamp, severity, or other attributes that led to disruption or jerk in the project during particular time period.

Fourth order time derivative of the project metric 112, on the other hand, can give an efficiency index of the project metric 112, which can indicate the efficiency or inefficiency caused by the disruption, magnitude of efficiency, reasons thereof, or other attributes that led to efficiency or snap or jounce in the project during particular time period. Efficiency index can be measured within a defined range, wherein if the efficiency index is within the range, the project, at that instant of time, can be detected as efficient in context of the concerned project metric 112. Similarly, if the efficiency index is below or above the range, the project can be declared as inefficient. The degree of efficiency or inefficiency can also be computed to evaluate the magnitude of impact on the project because of the detected efficiency. As discussed above, a disruption detected by the disruption index may not always lead to inefficiency as it may not be outside the defined range. Once computed, the disruption metric 122 comprising the disruption index or efficiency index or both can be presented on an output device 130 with respect to an achievement curve 132, wherein the achievement curve comprises display of planned or actual values of one or more project metrics 112. Presentation of the disruption metric 122 along with the achievement curve 132 can help a user to understand the reason, severity, location, timestamp, or other attributes behind disruption or efficiency in a project or program through one or more project metrics 112, which the first and second order time derivatives are not able to present.

It should be appreciated that although the present disclosure has been made with respect to a single disruption index and a single efficiency index, multiple disruption indices and or or efficiency indices can be derived from a combination of one or more project metrics so that more comprehensive analysis of disruption and efficiency in a particular project or program can be made. The present disclosure relates to computation of a third or higher order time derivative of one or more project metrics 112, wherein the computation of higher order time derivatives includes proper and efficient data management and requires accurate calculations, which can be performed by an electronic device such as a computer, server, service, a tablet, a cell phone or the like. Thus, the electronic device can access the database 110 and retrieve the project metric 112 for analysis. In an embodiment, the achievement curve 132 can be multi-dimensional such that the curve can be represented as a surface, volume, or other dimensional representation (e.g., contour plots, heat maps, topologies, etc.).

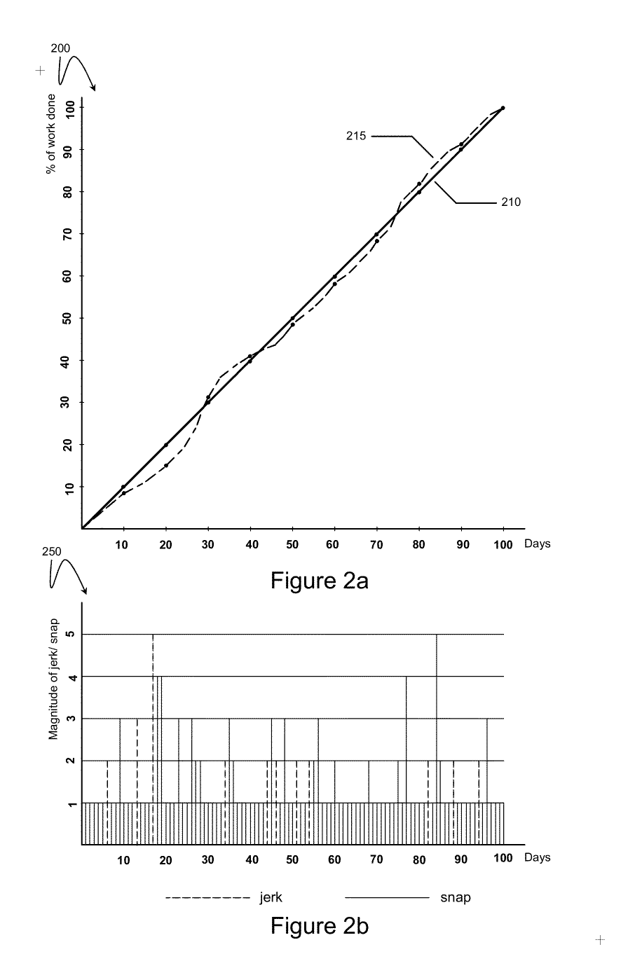

FIGS. 2A and 2B illustrate exemplary graphs showing disruption or jerk or efficiency or snap or jounce in a project through analysis of a project metric 112 with respect to time. In the present disclosure, as an exemplary illustration, the graphs are drawn for “percentage of work completed” as the project metric 112. The graphs can help in understanding the disruptions or efficiencies that occur during a project. FIG. 2A illustrates a projected achievement curve 210 for a project metric 112 (percentage of work completed for example) with respect to time and also illustrates the actual obtained achievement curve 215 for the project metric 112 of the project, plotted over percentage of work completed against time period in two axis. FIG. 2B, on the other hand, through disruption metric 122 comprising one or more disruption and efficiency indices, illustrates the magnitude and location of jerk or snap in the project. FIG. 2A and FIG. 2B can be described in a better manner as below.

FIG. 2A illustrates a graph 200 for percentage of work completed over time period T. In the present exemplary embodiment, “percentage of work completed” depicts a project metric 112 and is expressed as work completion percentage taken along Y axis. Amount of time taken to finish the specified amount of work is illustrated on X axis as time period T of the project. For illustration and simplicity, percentage of work completed is divided into 10 divisions, wherein each division indicates 10% of project work completed. Time period T along X axis can be divided into number of days after which the work rate is to be calculated and in the present illustration, the defined time period interval is 10 days. Therefore, after every 10 days, the percentage work completed is calculated for the present illustration. A projected work completion achievement curve 210 presenting the expected progress of the project can be estimated and drawn on the graph 200. Curve 210 can be drawn and defined before the project is initiated. The projected work completion curve 210 represents the percentage of work expected to be completed at defined time period intervals. For example, in the present illustration of FIG. 2, 10% of work involved in the project is expected to be completed within first 10 days and 50% of the work is expected to be completed within 50 days from initiation of the project. This work rate, in the present illustration, would lead to 100% work completion after 100 days. Therefore, a project or program manager or a user can plan that the project will be completed in 100 days and that the project be monitored after every 10 days to understand the progress of the program.

An actual work completed achievement curve 215 is drawn on graph 200 to represent actual percentage of work completed during the time period T. As has earlier been mentioned, “percentage of work completed” is merely an exemplary project metric 112 and any other project metric such as resource utilized or cost incurred, can be used independently or in combination with other project metrics. In an embodiment, curve 215, can also be referred to as achievement curve 132 interchangeably, whereas in an alternate embodiment, the curve 215 can be different from achievement curve 132 in terms of the manner in which their respective project metrics are processed, evaluated, or analyzed. As can be seen from curve 215, even though projected work to be completed after the first 10 days was 10%, the actual work completed was 9%, leading to a lag of 1%. Similarly, even though the projected work to be completed after the first 30 days was 30%, the actual work completed was 32%, leading to a delta of 2% over the projected schedule. As can be seen, the actual work completed curve 215 merely depicts whether the project metric 112 is ahead of or behind the planned projected curve 210 but does not explain or give any details of the reasons, location, timestamp, or activity giving rise to such a lag or leap. Although this document references “derivatives”, one should appreciate that such values can be calculated based on difference in discrete values at points in time.

Project analysis engine 120 can access project database 110 and fetch data related to “percentage of work completed” as the project metric 112 and compute third order time derivative of the project metric 112. The engine 120 can then generate a disruption metric 122 as a function of the third order time derivative, wherein the disruption metric 122 comprises of a disruption index that is derived from the third order time derivative and represents a jerk or disruption in the project due to the selected project metric 112. The disruption metric 122 can also comprise an efficiency index that is derived from fourth order time derivative of the project metric 112 and represents a snap or jounce or efficiency in the project when seen with respect to the selected project metric 112.

For simplicity, the disruption index and the efficiency index can be illustrated as units of disruption and units of efficiency respectively, wherein the units depict the magnitude of jerk or snap. It is understood that disruption index represents third order time derivative and efficiency index represents fourth order time derivative and therefore both the values have different units of measurement with respect to time. However, for illustration purposes and sake of better understanding of both the indexes, the unit of measurement for disruption index and efficiency index has been kept same. To further illustrate FIG. 2B, disruption index representing jerk has been considered to result in lag (negative disruption) in schedule by n units, and efficiency index, representing snap, has been considered to result in leap in schedule by m units. In actual implementation, the index can also include negative values indicating negative or positive disruption or indicating efficiency or inefficiency in the program, with the scale of negative or positive values representing magnitude of disruption or efficiency. Also, although the present computations for disruption and efficiency have been done with respect to “days” as the unit of time, in actual implementations, the unit can be hours, minutes, seconds, or other time periods.

When mapped with respect to time T, the disruption and efficiency index units can present the location of jerk or snap, event causing the jerk or snap, severity of jerk or snap, or time duration of the event causing the jerk or snap. FIG. 2B illustrates a schematic representation 250 showing disruption and efficiency indices by means of units or magnitude of jerk or snap with respect to time period T. As discussed earlier, although the present illustration represents third and fourth order time derivatives, in actual implementation, any higher order time derivative can be utilized for assessment of disruption and efficiency parameters. In FIG. 2B, magnitude (absolute value) of jerk or snap is represented through disruption and efficiency indices along Y axis and time period T is represented along X axis in the form of days.

In the present exemplary embodiment, FIGS. 2A and 2B are shown with respect to each other and map in terms of time vs. project metric behavior. To identify jerk and snap clearly, jerk is represented through a dotted line and snap is represented through a continuous line. As was noticed in FIG. 2A, after the first time period of 10 days, the actual project work completed was 9%, which was a lag of 1% over the projected completion of 10%. FIG. 2B can, for this first time period (i.e., per day), through the disruption and efficiency indices stored in the disruption metric 122, identify and present the reason, location, and severity of the jerk or snap though the magnitude of unit of jerk or snap. For example, it can be noticed from representation 250 that there was a jerk or disruption of 2 units on the 7'th day of the project and a snap or efficiency of 3 units on 9'th day of the project, which lead to an overall percentage of work completion as 9%. A project manager or other stakeholder can, based on the representation 250, point to the event responsible, location, duration, and severity of the jerk (on 7'th day) and snap (on 9'th day) so as to understand the rationale behind the overall behavior of the project metric 112 and take a more informed decision on the project or program including allowing project teams to take necessary steps to improve the identified reasons for jerks. Reasons for disruption and efficiency can be measured and evaluated based on the details of the activities undertaken during the days or time of jerk or snap. In an embodiment, multiple project metrics can be evaluated simultaneously to assess and evaluate one or a combination of parameters that affect the project.

Similar to above, FIG. 2A shows that the percentage of completion after 20 days is 15%, which, in fact, was planned for 20%. FIG. 2B correspondingly represents a series of jerks and snaps between days 11 to 20, wherein there is a jerk of 3 units on day 13, another jerk of 5 units on day 17, a snap of 4 units on day 18, and a snap of 4 units on day 19. As would be noticed, a higher magnitude of jerk corresponds to a higher severity disruption, and likewise a higher magnitude of snap corresponds to higher efficiency. In an embodiment, continuous jerks or snaps can indicate continuous disruption or efficiency, and therefore the representation 250 can indicate the duration, extent, severity, and timestamp of jerk or snap. In another embodiment, the time period interval for representation 250 can also be in hours, minutes, or even seconds for accurate assessment of the cause and extent of disruption or efficiency.

Table 1, with reference to FIGS. 2A and 2B, illustrates the variation in project metric (% of work completed) due to multiple disruptions and efficiencies (assuming efficiencies are positive and depict leap in work completed) with respect to time over the period of the project.

| | | Magnitude | Total % of |
|---|---|---|---|
| | Magnitude | of Snap | work |
| Day | of Jerk (unit) | (unit) | completed |
| 6 | 2 | | 3 |
| 9 | | 3 | 8 |
| 13 | 3 | | 8 |
| 17 | 5 | | 6 |
| 18 | | 4 | 10 |
| 19 | | 4 | 14 |
| 23 | | 3 | 20 |
| 26 | | 3 | 25 |
| 27 | | 2 | 27 |
| 28 | | 2 | 29 |
| 34 | 2 | | 32 |
| 35 | | 3 | 35 |
| 36 | | 2 | 37 |
| 44 | 2 | | 42 |
| 45 | | 3 | 45 |
| 46 | 2 | | 43 |
| 48 | | 3 | 47 |
| 51 | 2 | | 47 |
| 54 | 2 | | 47 |
| 55 | | 2 | 49 |
| 56 | | 3 | 52 |
| 60 | | 2 | 57 |
| 68 | | 2 | 66 |
| 75 | | 2 | 74 |
| 77 | | 4 | 79 |
| 82 | 2 | | 81 |
| 84 | | 5 | 87 |
| 85 | 2 | | 89 |
| 88 | 2 | | 89 |
| 94 | 2 | | 92 |
| 96 | | 3 | 96 |

Graphs 200 and 250 in FIGS. 2A and 2B of the present embodiment are drawn and described with respect to a projected achievement curve 210 and an actual achievement curve 215 for a defined project metric 112 and show disruptions and efficiencies in the program through disruption and efficiency indices (represented as unit or magnitude of jerk or snap). In some embodiments the projected curve 210 can be generated through a predetermined execution model stored in the project analysis engine 120 and can be indicative of the pattern of execution of the project proposed by the manager before initiation of the project or program. Projected curve 210 can also be planned based on historical project or program information, inputs from subject matter experts, budget involved, among other parameters. A plurality of patterns of proposed execution models can be stored in the project analysis engine 120 and the project analysis engine 120 can be configured to select one of the proposed execution models from the plurality of execution models. The proposed execution model can be related to one or more project metrics 112 or can be independent of the metrics 112.

Graph 200, representing the actual curve 215, can be presented based on a proposed execution model with respect to at least one of the project metrics 112, wherein the execution models can be manually or automatically configured to select desirable project metrics, change the time interval for measuring performance of one or more project metrics, change performance and assessment criterion, among other attributes. For example, in one execution model, the time interval of assessment can be fixed and equal duration, whereas in another execution model, an appropriate time interval can automatically be defined, adjusted, or changed at run time to best represent the behavior of project metrics 112 or a desired granularity of detail. The project analysis engine 120 can automatically select appropriate time interval as the time period T and perform analysis of the project. The analysis engine 120 can also have a look up table having a set of time periods at which the database 110 can be accessed. Project analysis engine 120 can access and analyze project metrics 112 to derive disruption metric at any time interval selected by a user or manager. The user can request for access of project metric from the database 110 earlier to a predetermined time, at which time the project analysis engine 120 identifies the time period T and performs access of project metric and analysis of the same to identify disruption in the program at user requested time period.

As mentioned earlier, in the current exemplary representation 250, jerks were assumed as sudden negative disruptions that impact the performance of the program and snaps were assumed as positive efficiencies that are created at different times and improve the performance of the program. However, at the same time, it would be appreciated that representation 250 can also be configured to merely represent jerks, whether positive or negative. In this case, the positive jerks can be represented as straight lines and negative disruptions can be represented as dotted lines. For example, typically start of a new activity at time T₂ would cause a sudden but desirable increase in man-hours, and therefore a higher positive disruption or jerk computed on man-hours at time T₂ would indicate a planned progress in the program, wherein higher the magnitude of jerk (third order time derivative), higher is the positivity.

Project analysis engine 120 can be configured to generate recommendations to a project manager to manage disruption metric 122 in a program based on comparison between projected curve 210 and an actual curve 215, wherein the recommendations can comprise actions to minimize disruptions or maximize snaps in the program. The project analysis engine 120 can also help in optimizing disruption metric 122 of one or more project metrics 112 based on needs of the program manager. In some embodiments, analysis engine 120 can compare characteristics of disruption or efficiency indices (e.g., jerk and snap respectively) to known event signatures. When the characteristics suitably match such signatures, analysis engine 120 can construct a notification or recommendation on corrective actions as derived from information stored within or associated with the known event signatures.

Program analysis engine 120 can also be configured to calculate fifth or higher order time derivatives along with third and fourth order time derivatives of one or more project metrics 112 of a program. Third order time derivative and fourth order time derivative of the project metrics 112 can provide disruption index and efficiency index of the project metrics 112 respectively, whereas fifth or higher order time derivatives can further help in deeper understanding of the change in snap with respect to time and impact of this change on program performance, or for measuring other desired attributes, which can help in managing the program in a better and efficient manner. It should be appreciated that the nature of higher-order derivatives, such as fifth order time derivative, is such that any noise on the original signal commonly results in increased noise on the derivative signals, and therefore whether the noise shown in third order time derivative of the metric 112 represents a false positive can be evaluated in the fourth order time derivative and so on. Also, a control or limitation on variation in higher order derivative can control the behavior of all lower order derivatives and therefore in certain cases, it might be more beneficial to limit the fifth or higher order derivatives as part of controlling the program performance. Fifth order time derivative is commonly also referred to as crackle and sixth order time derivative is commonly referred to as pop. If desired, the system 100 can be configured with an objective to monitor and limit the sixth order time derivative so as to control and assess the performance of the project with higher level of sensitivity.

Project analysis engine 120 can generate a disruption metric 122 comprising mean square derivative (MSD) value of third order time derivative of one or more project metrics 112 of a program, wherein mean square derivative (MSD) value is a sum of squares of periodic disruption values or jerks observed over a number of time periods. MSD value can be computed by calculating third order time derivatives of a project metric at periodic time intervals (such as weekly) of a defined duration of project execution (such as 6 months) and then calculating mean of the derivative values. MSD value can be stored in the disruption metric 122 along with disruption and efficiency indices. Disruption index can also be configured to include an absolute value derived from the third order time derivative of one or more project metrics 112. Such absolute values have already been illustrated in FIG. 2B. In another implementation, disruption index can include cumulative disruption over a defined period of time, wherein the cumulative disruption can include a sum of all absolute values derived from the third order time derivatives for the defined period.

Project analysis engine 120 can generate a disruption metric 122 comprising mean square derivative (MSD) value of fourth order time derivative of one or more project metrics 112 of a program, wherein mean square derivative (MSD) value is a sum of squares of periodic efficiency values or snaps observed over a number of time periods. MSD value can be computed by calculating fourth order time derivatives of a project metric at periodic time intervals (such as daily) of a defined duration of project execution (such as 1 month) and then calculating mean of the derivative values. MSD value can be stored in the disruption metric 122 along with disruption and efficiency indices. Efficiency index can also be configured to include an absolute value derived from the fourth order time derivative of one or more project metrics 112. Such absolute values have already been illustrated in FIG. 2B. In another implementation, efficiency index can include cumulative efficiency or inefficiency over a defined period of time, wherein the cumulative efficiency can include a sum of all absolute values derived from the fourth order time derivatives for the defined period.

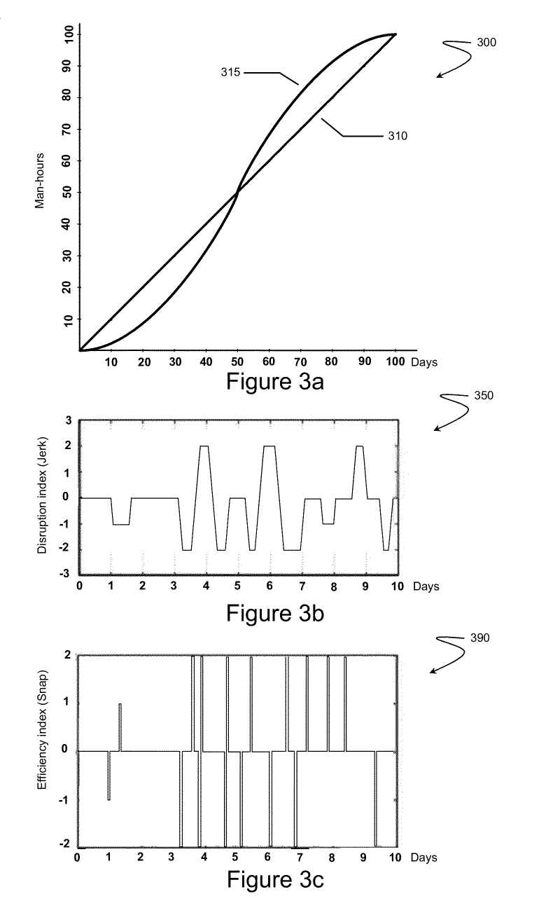

FIG. 3A represent an S-curve 315 with respect to a project metric 112 such as man-hours and time. Any other suitable project metric based on output, cost, scope of work, procurement, logistics, risk, communication, human resource plan, quality, or number of activities can also be incorporated. S-curve 315 is an S-shaped graph produced by Sigmoid formula which calculates the cumulative expenditure of certain project metrics against time. S-curve 315 is typically used against estimates such as projections or budgets on such project metrics 112. The projected curve 310 represents the projections of total number of man-hours planned to be used over the period of 100 days of the project. For simplicity, the projected curve 310 has been shown with a slope of 1, with 10% of the work intended to be covered in 10 days and 100% of the work intended to be covered in 100 days. As can be seen, the S-curve 315 typically represents a slow start and a slow finish with varying acceleration in between, wherein the man-hours consumed are lower than projected in the first half and higher in the second half. For example, after 30 days the number of man-hours to be consumed is planned to be 30 and the actual consumption is 15. Similarly, after 90 days, the number of man-hours to be consumed is planned to be 90 and the actual consumption is 98.

FIG. 3B represents a graphical representation 350 illustrating jerks or disruptions for a short time periods within the project shown in FIG. 3A. Representation 350 shows the third order derivatives of the man-hours project metric 112 with respect to the actual progress curve 315 and illustrates the values of third order time derivatives of the metric 112 for the first 10 days of the project. As a can be seen, the disruption index or jerk can have actual values from negative to positive, wherein the negative disruptions can indicate negative jerks (unanticipated or unexpected) and positive disruptions are expected jerks representing start of new activities, allocation of new man-hours, among others. Furthermore, magnitude of disruption index, as shown on Y axis can indicate the level of disruption, which can later be compared with defined thresholds, so as to take necessary action such as allocating additional man-hours to complete the activity at hand. For example, in case −1 to +1 is the defined threshold for third order time derivatives of man-hours project metric, disruption due to activities undertaken on Day 4 of the program is higher than the defined threshold and therefore such activities along with remedial measures can be reported to the project team on Day 4 itself. It should also be noted that, in the present illustration of FIG. 3B, the frequency of disruption is more in the middle of the time duration of 10 days and highest around the 5'th day, whereas the disruption is relatively lower in the beginning and in the end. However, such a representation is purely project or program specific and can vary.

FIG. 3C represents a graphical representation 390 illustrating snap or jounce or nature of efficiency for a short time period of the project shown in FIG. 3A. Representation 390 shows the fourth order derivatives of the man-hours project metric 112 with respect to the actual progress curve 315 and illustrates the values of fourth order time derivatives of the metric 112 for the first 10 days of the project. Efficiency index is a further time derivative of the jerk (disruption index) and therefore helps analyze the pattern of change of the jerk so as to evaluate whether the change caused any efficiency impact in the implementation of the program.

As a can be seen, the efficiency index or snap can have actual values from negative to positive, wherein the negative values can indicate inefficiencies (such as undesirable disruptions or events leading to lag in projects) and positive values can indicate efficiencies such as on-time or before time start of new activities, email communications indicating no change in scope of an activity, reduction in man-hours, among others. Furthermore, magnitude of efficiency index, as shown on Y axis can indicate the level of efficiency, which can be compared with defined thresholds, so as to take necessary action for highlighting the event responsible, activities undertaken in the event, people responsible for those activities, duration of those activities, importance of each of those activities, and correct or continue the activities depending on efficiency or inefficiency. It should also be noted that, in the present illustration of FIG. 3C, the frequency of efficiency or inefficiency is more in the middle of the time duration of 10 days and highest around the 5'th day, whereas the frequency of variation is relatively lower in the beginning and in the end. However, such a representation is purely project or program specific and can vary.

The system 100 can further be configured to generate signatures based on certain trends, types, or magnitudes of disruptions, efficiencies, or inefficiencies and store such signatures in program database 110. Such signatures can be generated based on experience of subject matter experts on anticipated disruptions or efficiencies, previous signatures in same or other programs, or common types of jerks or snaps that are generated in a particular type of project. The signatures can either be stored in the database 110 in an encoded format or any other known format, which can help their efficient retrieval or processing by the program analysis engine 120. The signatures can also be updated or new signatures can be formed as the program proceeds over a period time, wherein such update or formation can be based on earlier disruptions detected in the same program, new learning from other parts of the program or from other projects in the same program. The signatures can be configured to store disruption or efficiency characteristics along with their possible reasons and resolutions. The database 110 can be configured to classify the signatures based on whether they relate to efficiencies or disruptions, type of program or project, project metrics involved, % of confidence in suggested resolution or other parameters.

Matching of actual jerks or snaps in respect to their position, severity, duration, type, event responsible, or other parameters, with signatures stored in the database 110 can help extract recommendations stored corresponding to the matched jerks or snaps in the signature. For example, in case the actual earned value in a software development project decreases by 3.5% in the month of May due to loss of 45 man hours, jerk (third order derivative) of this actual event can be compared with the list of jerks presents in the software development signatures and once a match is found to be representative of the magnitude and other characteristics of the disruptive event, recommendation stored corresponding to the matched signature can be extracted from the database 110 and sent to the program team for implementation and resolution of the jerk to create overall efficiency.

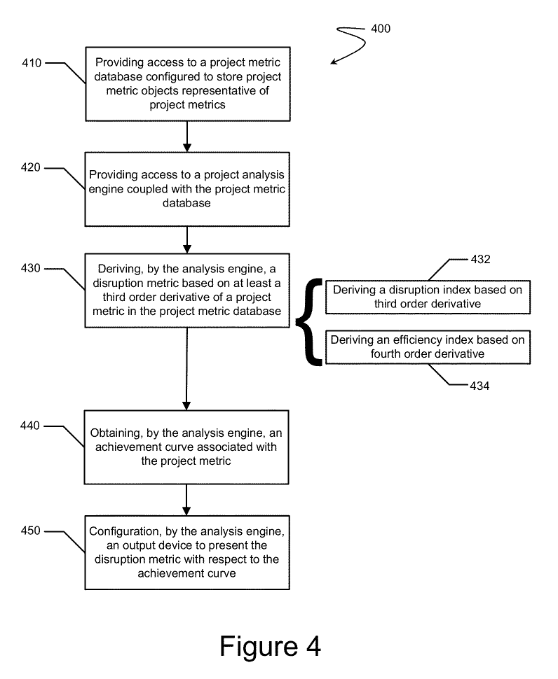

FIG. 4 presents a method 400 for program management to identify disruptions or efficiencies in a program or project with respect to one or a combination of project metrics of the program. Step 410 can include providing access to a project database that stores project metric objects of one or more project metrics. The project metrics can include manpower; cost incurred; resources utilized; logistics; schedule; test; inspection work, project, program completion percentage; personnel usage; email communication; earned value; man-hour usage; or other program related metrics; wherein the project metric objects can include data related to the project metrics obtained at a particular time period.

Step 420 includes providing access to a project analysis engine coupled with the project database. The project analysis engine can be coupled to the project database directly or via a network, wherein the project database can be present at same location or at a remote location from the project analysis engine. The network can be LAN, WAN, VPN, cell phone, mesh network, peer-to-peer network, or the like. The project analysis engine can access the project database and can select the project metric(s) to be analyzed. The project analysis engine can be implemented or installed for execution on a dedicated server, a shared server, user's or client machine, or on any other accessible hardware. The project analysis engine can be accessed either as an independent application software, software as a service, part of the program management software, or other types of implementations.

Step 430 includes the analysis engine deriving a disruption metric based on at least a third order time derivative of a project metric that is stored in the project metric database. The selected project metric of the program can be analyzed by reading project metric data over a time period and calculating a third order time derivative of the project metric at one or more time points to assess whether a jerk has happened in the program at any of those time points. Each jerk can represent a disruption (desired or undesired) that occurs the program. The disruption metric can be generated as a function of the third order time derivative of the project metric, and can be represented as f(d³PM/dt³), where PM represents the selected project metric. It should be appreciated that although the disruption metric has been described in the present disclosure as a function of the third order time derivative of the project metric, which indicates an indirect computation of the metric from the project metric, the disruption metric can also be directly implemented as equal in value to the third order time derivative of the project metric rather than being a function thereof. Alternatively, based on the project metric involved and program characteristics, the disruption metric can also be computed as a third order time derivative including a constant or offset value. Furthermore, the disruption metric can also represent multiple third order time derivatives of the project metric across different time periods and store them together as part of the metric.

Step 432 includes deriving a disruption index based on the third order time derivative of the project metric, wherein the disruption index can be stored in the disruption metric. As the third order time derivative can be computed multiple times for the same project metric across the span of the project or program, multiple disruption indexes can be generated and stored in the disruption metric. Step 434, on the other hand, includes deriving an efficiency index based on fourth order time derivative of the project metric, wherein the efficiency index can be stored in the disruption metric. In an embodiment, a separate metric such as efficiency metric can also be created to store the fourth order time derivatives of the selected project metric. Storing of the disruption as well as efficiency indexes across time periods in the disruption metric, can however allow seamless and combined analysis of rate of change of acceleration of the project metric as well compute efficiencies or inefficiencies created by the jerk (rate of change of acceleration) in the project.

Disruption index, calculated in step 432, is a result of the third order time derivative of the project metric and indicates jerks that occur in the program, whereas, efficiency index, calculated in step 434, is a result of the fourth order time derivative of the project metric and indicates snaps or efficiencies or inefficiencies that occur in the program due to or irrespective of the disruption identified in the program. The disruption index and the efficiency index can also be computed such that they are based on one or a combination of project metrics, and can represent multiple jerks and snaps identified across project metrics during a given a period of time. For example, at time T₁, third order time derivative of man-hours and % of work completed, as separate project metrics, can be computed and evaluated for whether disruptions as indicated at T₁ exist for both metrics and whether such disruptions show some correlation in terms of span of disruption, activity causing it, impact of such disruption, among others. If such a correlation exists, a more consolidated and accurate analysis of the activity involved in causing the disruption can be conducted with higher confidence factor.

Step 440 includes obtaining an achievement curve associated with the project metric through the program analysis engine. The achievement curve can represent actual or planned progress of the program or project with respect to one or a combination of project metrics such as planned schedule, cost, expenditure rates, man-hours, installation rates, or earned value, after or before initiation of the project. If desired, multiple achievement curves can be obtained for one or a combination of project metrics with respect to time to analyze the impact of each metric on the project. In another instance, achievement curve can also be modeled or simulated based on previous similar projects, projections of subject matter experts who can make objective assumptions around efficiency with which certain activities would be carried out and also efficiency with which transition between activities would take place (start:stop; ramp-up:ramp-down), or known simulation models such as Monte Carlo techniques.

Achievement curve can be represented as a mathematical equation (e.g., a fit curve), which aims to represent utilization of resources over the proposed time of the project. The curve can also be illustrated as a combination of two or more curves that help represent side by side comparisons of actual time and expenditure components (actual project metric values) vs. proposed time and costs allocations of specific resources (planned values for the project metrics).

Step 450 includes configuring an output device to present the disruption metric with respect to the achievement curve. The output device can be any web browser, cell phone, tablet, printer, and the like through which the disruption metric can be presented with respect to the achievement curve, which can help the user to assess the location, reason, duration, severity or other attributes of disruption or efficiency through the jerks and snaps that are represented via disruption index and efficiency index. As mentioned above, the disruption metric is a function of the change in acceleration of the project metric or, in other words, represents the manner in which the project metric changes over a short span of time, which computation highlights the instantaneous or sudden disruptions in steady ramp rate and therefore highlights jerks in the program progress, which can be analyzed with respect to the planned behavior or acceleration pattern. The project analysis engine can process the achievement curve with respect to the disruption metric and present the outcome including recommendations to overcome disruption, activities to be closely monitored to mitigate disruptions, risk areas, portions where additional cost or man-hours are estimated, personnel responsible for the disruption, among others suggestions on the output device.

It should be appreciated that the present system 100 and method 400 for program management can be applied to and implemented in any short term or long term program, wherein such a program can include one or more projects. A program can be selected from any business vertical such as engineering, construction, software development, business transformation, or other verticals.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, the terms “coupled to” and “coupled with” are also used euphemistically to mean “communicatively coupled with” in the sense that two networked devices are able to communicate with each other over a network, possibly through one or more intermediary devices.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A project management system comprising:
a project database storing project metrics associated with a project with respect to time; and
a project analysis engine coupled with the project database and configured to:
derive a disruption metric as a function of at least a third order time derivative of at least one of the project metrics;
obtain a project achievement curve with respect to the at least one of the project metrics; and
configure an output device to present the disruption metric with respect to the project achieve curve.

2. The system of claim 1, wherein the disruption metric comprises at least a fourth order time derivative of the at least one of the project metrics.

3. The system of claim 1, wherein the disruption metric comprises a minimum square derivative (MSD) value of the at least a third order time derivative of the at least one of the project metrics.

4. The system of claim 3, wherein the disruption metric comprises an MSD disruption index.

5. The system of claim 4, wherein the MSD disruption index comprises a sum of the squares of periodic disruption values over a number of time periods.

6. The system of claim 3, wherein the disruption metric comprises an MSD efficiency index.

7. The system of claim 6, wherein the MSD efficiency index comprises a sum of the squares of a periodic efficiency values over a number of time periods.

8. The system of claim 1, wherein the disruption metric comprises an absolute value of the at least a third order time derivative of the at least one of the project metrics

9. The system of claim 8, wherein the disruption metric comprises a cumulative disruption.

10. The system of claim 9, wherein the cumulative distribution comprises a sum of absolute distributions over a number of time periods.

11. The system of claim 8, wherein the disruption metric comprises a cumulative efficiency.

12. The system of claim 11, wherein the cumulative efficiency comprises a sum of absolute efficiency over a number of time periods.

13. The system of claim 1, wherein the disruption metric represents a project efficiency.

14. The system of claim 1, where the at least one of the project metrics includes one of the following metrics: a cost metrics, a resource metrics, a completion metric, a personnel metrics, a man-hour metrics, an inspection metrics, a test metrics, a quality metrics, an earned value metrics, and a quantity metrics.

15. The system of claim 1, wherein the project achievement curve comprises a proposed execution model with respect to the at least one of the project metrics.

16. The system of claim 15, wherein the project analysis engine is further configured to select the proposed execution model from a plurality of execution models.

17. The system of claim 1, wherein the distribution metric is derived with respect to a plurality of time periods having equal duration.

18. The system of claim 17, wherein the project analysis engine is further configured to automatically determine the duration of the time periods.

19. The system of claim 1, wherein the project analysis engine is further configured to recommend an action to optimize the disruptive metric based on a comparison of the project achievement curve and disruptive metrics.
